(19) United States
(12) Patent Application Publication
(10) Pub. No.: US 2019/0337247 A1
(43) Pub. Date: Nov. 7, 2019

(54) Tire Repair Apparatus

(71) Applicant: Trydel Research PTY LTD, Ferntree Gully, Victoria (AU)

(72) Inventor: Terry DOWEL, Melbourne, Victoria (AU)

(21) Appl. No.: 16/467,794

(22) PCT Filed: Dec. 8, 2017
(86) PCT No.: PCT/AU2017/051350

§ 371 Date: Jun. 7, 2019

(30) Foreign Application Priority Data
Dec. 8, 2016 (AU) 2016905062
Aug. 3, 2017 (AU) 2017903070

(51) Int. Cl. B29C 73/16

(52) U.S. Cl. CPC B29C 73/166

(57) ABSTRACT

A tire repair apparatus is described for dispensing sealant formulation which is substantially formed of PET and provided with an integrally formed neck or base inlet which itself is additionally provided with a valve or plug within an internal channel thereof. The apparatus is a more environmentally-friendly dispenser and provides for advantages during dispensing of sealant.

### FIELD OF THE INVENTION

This invention relates to an apparatus for the repair of tires following a puncturing incident. More particularly, the present invention relates to an apparatus for dispensing a sealant formulation into a tire following a puncturing incident.

### BACKGROUND OF THE INVENTION

Any reference to background art herein is not to be construed as an admission that such art constitutes common general knowledge in Australia or elsewhere.

Sealant compositions for pneumatic tires have been developed to provide temporary sealing of pneumatic tires after a puncturing incident has occurred. The sealing of punctured tires with such compositions is a stop gap measure in that it serves the purpose of making the vehicle with the punctured tire drivable again at a limited speed for a limited period of time and/or a limited distance. After that the tire is either to be replaced or, if possible, repaired.

Tire puncture repair kits were developed to conveniently deliver such sealant formulations and restore vehicle mobility following a puncture event, thereby eliminating the need to carry a spare wheel and associated equipment. This afforded a quicker, easier and safer means of restoring vehicle mobility as well as saving weight.

The simplest such tire repair kits consist of a simple squeezable bottle with a hose extending from the lid which fits over the tire valve stem. Prior to use, the valve core must be removed from the tire valve which requires additional time during the repair operation and runs the risk of loss of the valve core. This operation also results in a substantially complete loss of air from the tire thereby requiring more time to reinflate. The tire should also be moved into a position such that the valve stem is generally within the 4 to 8 o'clock position to enable dispensing. Similar repair kits are available with a pressurised aerosol container instead of a squeezable bottle. These do not require the removal of the valve core as they typically do not contain fibre or solid particles as they rely on a cross-linking action with latex or a vinyl resin.

More sophisticated kits may include a plugin compressor which connects to a canister of latex sealant that can be pumped into the tire using the generated pressure and so which can be used without having to remove the valve core. These kits are generally designed to be specific to each original equipment manufacturer (OEM) and, as only one sealant container is provided by the OEM, if a motorist should encounter a second puncture in any tire prior to replacing the repair kit then they will not be able to repair it. Some of these kits require specific connections and therefore can only be sourced and supplied by the car dealer, usually at significant expense to the motorist.

It would be desirable to provide for a tire repair apparatus which provides for greater flexibility in use and is more user friendly or at least offers a commercial alternative over those in the prior art.

### SUMMARY OF THE INVENTION

In one broad form, the present invention relates to a tire repair apparatus comprising a container with a body substantially made from PET (polyethylene terephthalate) and which comprises a body and a neck with an integrally formed inlet extending from the neck.

The present tire repair apparatus is advantageous in that it represents something of a universal container and dispenser of sealant formulation in that its design allows it to be used with any common pressurised air source and tire valve which therefore presents a useful and cost effective option in the tire repair kit aftermarket.

Most tire repair kits supplied by the OEM are designed for the sealant container to slide, when inverted, into a housing built into the compressor casing. The sealant container has a length of air hose, initially wound around the cap of the bottle, that is connected to the cap. Before the container can be located onto the compressor, the hose is unwound and once the container is placed in position the hose is then connected to the tire valve. There are variations in the way different OEM kits are designed and as such they are not always compatible and interchangeable with one another, thereby forcing the motorist to purchase replacement sealant containers from a limited selection of car dealers.

It would therefore be advantageous to provide for a replacement container of sealant to be available at e.g. tire repair shops and the like where the tire has been presented for inspection and repair or replacement. The replacement sealant container will need to be designed so that it is easily adapted for universal use without having to be located into the compressor housing.

The present invention provides for such a solution in that all that is required for sealant discharge into the tire is to connect (i) the compressor hose from the OEM or other kit to the air inlet of the present apparatus; and (ii) the outlet hose to the tire valve. The container will then need to be held inverted for the time it takes to transfer the sealant (around 45 seconds). After that there is no need to manually hold the bottle while the tire is being inflated.

Further, it has been found that a container having an integrally formed neck inlet through which pressurised air can be injected to pressurise the container and thereby effect the discharge of sealant formulation provides distinct advantages in terms of at least time savings in inflation of the tire being repaired. This is due to the vigorous aeration of sealant in the neck region just before it leaves the container and subsequently enters the tire in a foaming/aerated state thereby resulting in foaming sealant entering the tire early in the repair operation and more efficiently inflating the tire.

In certain embodiments, the present container is also provided with a pressure release system. This is a distinct advantage when a blockage develops in the system or compressors which provide for dangerously high psi levels, such as are freely available off the shelf in many retail outlets, are used then it is a distinct advantage to have a pressure release system to avoid an explosion with the uncontrolled release of sealant. The pressure release systems described herein allow for controlled release of pressure and sealant, in a much safer manner, and greatly reduce the risk of container explosion in such circumstances.

In one aspect, the invention resides in a tire repair apparatus comprising:
(a) a container having a body, a base and a neck, the container substantially made from PET;
(b) one of the neck or the base having an integrally formed inlet extending therefrom; and
(c) an outlet hose extending from an opening of the neck;

wherein, the neck or base inlet comprises a valve or plug within an internal channel thereof.

Preferably, it is the neck which has an integrally formed neck inlet.

In one embodiment, the container is made from at least 90%, preferably at least 95%, more preferably at least 98%, more preferably still at least 99% PET.

Suitably, the neck inlet is a tubular extension or spigot integrally formed with the neck.

In one embodiment, the neck inlet extends at substantially a right angle to the neck.

The internal channel of the neck inlet has a first opening which is continuous with the interior of the container.

The internal channel of the neck inlet has a second opening at an end of the neck inlet opposite that which is adjacent the neck of the container.

In one embodiment, the neck inlet internal channel is a threaded channel.

The opening of the neck inlet of the container is formed at an end of the neck opposite that which is adjacent the body of the container.

The outlet hose is connected to the opening of the neck to form a sealing engagement.

The outlet hose may extend away from the container vertically at substantially a right angle when the container is arranged with the neck inlet extending substantially horizontally from the neck.

The internal passage of the outlet hose is continuous with the interior of the container.

Suitably, a first end of the outlet hose may comprise a threaded portion on the internal passage.

Suitably, the base inlet, when present, may take any form as described for the neck inlet.

The base inlet may extend from the base to be substantially parallel with respect to an axis passing vertically through the length of the container body and through the centre of the opening of the neck.

In one embodiment, the tire repair apparatus may be substantially metal-free.

In certain embodiments, the tire repair apparatus may further comprise a pressure release device comprising a sealing face having a sealing spigot extending therefrom and passing through an aperture formed in the base of the container.

In one embodiment, the sealing spigot of the pressure release device forms a sealing engagement within the aperture. In such an embodiment, the sealing spigot of the pressure release device may form an interference fit within the aperture.

In an alternative embodiment, the pressure release system may further comprise a deflection baffle which engages with the aperture.

In this alternative embodiment, the deflection baffle engages with the aperture and the sealing spigot of the pressure release device is accommodated within the deflection baffle.

Suitably, the deflection baffle has at least one channel within which the sealing spigot of the pressure release device is at least partly accommodated.

Suitably, the at least one channel extends through the deflection baffle such that a continuous flow path is provided.

Preferably, the at least one channel is a central channel which is intersected by at least one additional channel.

Suitably, the at least one additional channel intersects the central channel at an angle less than 90 degrees, preferably less than 70 degrees, even more preferably less than 60 degrees.

In certain embodiments, the deflection baffle engages with the aperture by an interference fit but preferably the aperture is provided with a screw-threaded surface which engages with a screw-threaded portion on the deflection baffle.

Suitably, the pressure release device has an elongate body.

In embodiments, the pressure release device comprises at least one chamfered face to engage with the sealant container.

In certain embodiments, the pressure release device is a bar with a chamfered face at either end thereof.

In alternative embodiments, the pressure release device comprises a flange which, in use, locks against an overhang formed within the container.

The overhang may be formed by an indent in a wall of the container adjacent the base thereof.

Suitably, the flange of the pressure release device is formed from an extension of the sealing surface beyond the extent of a wall on the underside of pressure release device.

The sealing spigot may have at least one inclined face at an end thereof furthest from the sealing face of the pressure release device.

In one embodiment, the apparatus does not have a sealing film or like structure which must be broken or disrupted prior to or during use.

In a second aspect, the invention provides for a method of sealing a puncture in a pneumatic tire including the steps of:
(a) providing a tire repair apparatus comprising;
   i. a container having a body, a base and a neck, the container substantially made from PET and the container containing a sealant formulation;
   ii. one of the neck or the base having an integrally formed inlet extending therefrom;
   iii. an outlet hose extending from an opening of the neck and wherein the neck or base inlet comprises a valve or plug within an internal channel thereof;
(b) connecting the outlet hose to a valve of the pneumatic tire;
(c) supplying a fluid pressure through the neck or base inlet of the container;

to thereby discharge sealant formulation from the container into an internal chamber of the pneumatic tire and seal the puncture.

The various features and embodiments of the present invention, referred to in individual sections which follow apply, as appropriate, to other sections, mutatis mutandis. Consequently features specified in one section may be combined with features specified in other sections as appropriate.

Further features and advantages of the present invention will become apparent from the following detailed description.

### BRIEF DESCRIPTION OF THE DRAWINGS

In order that the invention may be readily understood and put into practical effect, preferred embodiments will now be described by way of example with reference to the accompanying figures wherein:

FIG. 1 is a perspective view of the exterior of one embodiment of a tire repair apparatus;

FIG. 2A is a partial view of a portion of the neck and neck inlet;

FIG. 2B is a sectional view of a portion of the neck and neck inlet along the line c-c shown in FIG. 2A;

FIG. 3A is a partial view of a portion of the neck and neck inlet with neck sleeve and plug;

FIG. 3B-3C are perspective views of the neck portion of a container with a partial neck sleeve in place and with and without air hose connector;

FIG. 3D is a perspective view of one embodiment of a partial neck sleeve;

FIG. 4 is a partial view of a portion of the neck and threaded neck inlet with an inlet valve for insertion

FIG. 5 is a perspective view of the exterior of a further embodiment of a tire repair apparatus;

FIG. 6 is a perspective partial view of the tire repair apparatus of FIG. 5 with a valve stem connector;

FIG. 7 is a perspective view of the exterior of yet a further embodiment of a tire repair apparatus showing attached compressor;

FIG. 8 is a view of sections of the valve stem connector of FIG. 7 and showing attachment thereof;

FIG. 9 is a perspective view of the base of still a further embodiment of a tire repair apparatus having a base inlet;

FIG. 10A-10C are a perspective view, side elevation view and sectional view, respectively, of a pressure release device;

FIG. 11 is a perspective view of a sealant container fitted with the pressure release device of FIG. 6A-C to form a pressure release system;

FIGS. 12A and 12B are an elevation view and a sectional view, respectively, of a deflection baffle for a pressure release system;

FIG. 13A is a perspective view of one embodiment of a sealant container with the deflection baffle of FIGS. 12A and 12B about to be located in the threaded aperture while FIG. 13B is a perspective view of the sealant container of FIG. 13A with the pressure release device of FIG. 10A-10C engaged with the deflection baffle of FIGS. 12A and 12B to form a pressure release system;

FIG. 14A to 14F show an alternative embodiment of a pressure release device alone and when fitted within a sealant container; and

FIG. 15 shows yet a further embodiment of a pressure release device when fitted within a sealant container.

### DETAILED DESCRIPTION OF THE INVENTION

Unless defined otherwise, all technical and scientific terms used herein have the same meaning as would be commonly understood by those of ordinary skill in the art to which this invention belongs.

While the discussion herein largely relates to the use of the present tire repair apparatus in the repair of large vehicle pneumatic tires, such as cars, vans and trucks, it will be appreciated that the invention is not so limited. Particularly, the present apparatus may find use in the repair of bicycle tires or indeed any inflatable tire having a valve stem for the input of sealant formulation and air.

In one aspect, the invention resides in a tire repair apparatus comprising:
(a) a container having a body, a base and a neck, the container substantially made from PET;
(b) one of the neck or the base having an integrally formed inlet extending therefrom; and
(c) an outlet hose extending from an opening of the neck;

wherein, the neck or the base inlet comprises a valve or plug within an internal channel thereof.

In one embodiment, the body of the container is made from at least 90%, preferably at least 95%, more preferably at least 98%, more preferably still at least 99% PET.

Suitably, the neck and the neck inlet are integrally formed with the container body.

It will be appreciated that the PET (polyethylene terephthalate) container body may be formed using co-polymers, as are known in the art, but it is preferred that such co-polymers and other additives are present in low amounts. Suitable co-polymers may include isophthalic acid, cyclohexane dimethanol (CHDM), diethylene glycol (DEG) or other co-monomers. Such co-polymerisation may be used to lower the melting point or otherwise alter the properties of the container in a favourable way but they will not significantly alter the advantageous properties of the PET as discussed herein. For example, to improve heat stability and resistance and mechanical strength of the PET bottle, a blend of polyethylene naphthalate (PEN) (often referred to in the PET bottle moulding industry as ‘Heat Set’ (Hot fill)) and PET is useful.

While PET is a commonly used polymer for various containers and articles for general use it has not been hitherto realised that it is particularly advantageous in the formation of a container to carry a sealant composition, as part of a tire repair kit. A PET container is of a significantly reduced weight compared with, for example, a polypropylene container of similar dimensions. A typical weight for an approximately 400 mL container, such as would be suitable for use in the present invention, might be around 40 g. Weight savings are of key importance to car manufacturers providing the present apparatus with a significant advantage.

PET is also relatively low cost and easy to manufacture into a desired shape for the container. It can, for example, be injection stretch blow moulded quickly and in high volumes in a production chain to produce the containers. The ability of the PET to be manipulated during formation of the container allows the neck and neck inlet to be integrally formed. This is of great importance as a similar neck inlet formed by drilling into the neck of the container after its formation would greatly weaken the structure. Extreme sealant container test requirements dictate that the container should withstand 7 bar pressure at a temperature of 70° C. The present container, blended with ‘Heat Set (Hotfill) and PET, can meet this requirement without damage at the neck inlet due to its being formed during formation of the container itself thereby resulting in an integral design. That is, the neck inlet is not formed on the neck of the container subsequent to manufacture of the bottle and is not bonded or retrofitted to the container but rather is one piece with the rest of the integrally formed container neck and body. It will therefore be appreciated that the presently claimed apparatus is not a mass produced commercial PET bottle adapted for a different use but, rather, is a bespoke design specifically made for the present purpose of dispensing sealant formulation at elevated pressures.

To pass the extreme pressure and temperature tests it is important that the container body or wall has a thickness sufficient to provide the desired strength. However, thicker walls mean increased material cost and increased weight in the final product. The wall thickness of typical polypropylene bottles supplied with tire repair kits is 3.5 mm, whereas the present PET containers are preferably about 0.8 mm in thickness, representing a decrease on wall thickness versus polypropylene of almost 4.4 times. Therefore, in one embodiment, the wall thickness of the body of the container is between about 0.6 mm to about 1.5 mm, preferably between about 0.7 mm to about 1.2 mm, more preferably between about 0.75 mm to about 1.0 mm and even more preferably between about 0.75 mm to about 0.9 mm.

The present PET container has been rated at 150 psi for a period of one week and shows significant ability to withstand high pressures for significant periods of time. This is particularly when the container is to be reused multiple times.

Further, it is useful that the PET container body can be transparent and so a user is able to visually observe the sealant formulation being dispensed and can easily judge when it has all been dispensed.

The use of a PET container body is also important for environmental reasons. It is estimated there are around 15 million unused latex sealant bottles supplied by the OEM reaching their expiry date every year since after 4 to 5 years latex sealants must be changed over for a new bottle by the car dealer's service division. This presents a very significant environmental disposal problem. The unused or used latex sealant bottles with attached hoses and complete with various metal parts are difficult and even impractical to recycle.

The present tire repair apparatus can advantageously be manufactured having no metal parts. This can be achieved by employing rubber plugs as opposed to metal valve cores in the neck inlet and/or base inlet and also having an all plastic hose to the tire valve connector instead of using a connector with a spring loaded spigot. To prevent sealant leakage, an O ring seal attached generally adjacent a second end of the outlet hose and forming part of a stopper located at the second end of the outlet hose may be used.

Therefore, in one embodiment, the tire repair apparatus may be substantially metal-free. That is, the tire repair apparatus may be substantially or entirely manufactured from plastics and/or rubber.

It will be appreciated that while the container shown in the figures is generally cylindrical, the invention is not so limited. A cylindrical container will generally be preferred for manufacture, strength and storage reasons but other useful shapes could be envisaged.

Suitably, the neck inlet is a tubular extension or spigot integrally formed with the neck. That is, in one embodiment, the neck inlet is a simple extension from the neck having an internal channel or bore to allow air or another fluid to pass through it and into the interior of the container.

In one embodiment, the neck inlet extends at substantially a right angle to the neck. While the formation of an exact right angle with the neck of the container is not important, it will be appreciated that for convenience in manufacture and use it is preferred that the neck inlet extend from the neck at an angle between about 80 to about 100 degrees.

The outlet hose may extend away from the container vertically at substantially a right angle when the container is arranged with the neck inlet extending substantially horizontally from the neck. That is, the neck inlet extends from the neck substantially horizontally when the container is resting on its base and, in that position, the beginning of the outlet hose extends vertically substantially at a right angle to the neck inlet.

The internal channel of the neck inlet has a first opening which is continuous with the interior of the container. The neck inlet is adapted to have a pipe or tube connected to it, in use, such that a pressurised fluid can be passed through the internal channel and enter the interior of the container to pressurise the interior of the container and effect discharge of the sealant from the outlet hose. The internal channel will therefore open at one end to the external environment (or pipe or tube if connected to a compressor or other pressurised fluid source) and at the other end will open into the interior of the container in the neck region.

In certain embodiments a neck sleeve may be inserted into an interior surface of the neck of the container and so may occlude the internal channel of the neck inlet from opening into the interior of the container. Such an embodiment does not change the operation of the neck inlet or its structure and the neck inlet's internal channel is still considered to open into the interior of the container as the air compressor hose connection incorporates a bridge that, when screwed into the neck inlet, forces open the sealing plug and/or the incoming pressurised fluid will make the neck sleeve flex and allow passage of said air into the interior of the container.

The neck sleeve will have a diameter approximately the same as that of the neck of the container but slightly less such that it can be slid into place inside the neck of the container. As will be described in relation to the figures, such a neck sleeve may be useful to assist in holding a plug in place within the internal channel of the neck inlet to prevent egress of the sealant formulation prior to use of the tire repair apparatus.

As described, the internal channel of the neck inlet has a second opening at an end of the neck inlet opposite that which is adjacent the neck of the container. That is, the opening is formed where the neck inlet is integrally formed with the neck. It is at this point that, in certain embodiments, the plug may be inserted and held in place by the neck sleeve.

In one embodiment, the neck inlet internal channel is an internally threaded channel. In this embodiment, the plug may not be used and so the neck sleeve may not be necessary. The neck inlet can be formed with an internal thread to thereby receive a standard valve arrangement such as are known in bicycle and car tires. This valve can serve to prevent the accidental release of sealant formulation but the valve core will open to allow the passage of a pressurised fluid, during use, into the interior of the container.

In certain embodiments, the neck sleeve is a partial neck sleeve. That is, the partial neck sleeve is not in contact with the entire circumference of the inner surface of the container neck. Put another way, the partial neck sleeve is provided with an opening in a body thereof which sits in contact with the inner surface of the container neck. In a preferred embodiment, the partial neck sleeve is C-shaped. Suitably, the partial neck sleeve is provided with a plug extending from a face thereof. This plug may be located by interference fit within the internal channel of the neck inlet of the container. The plug may have a pin extending from an end face of the plug which, in use, extends into the internal channel. The pin may be a splined pin. Preferably, the partial neck sleeve is a unitary design.

The opening of the neck of the container is formed at an end of the neck opposite that which is adjacent the body of the container. This opening may be a standard opening as would be seen on a PET drinks bottle, that is, the opening may be formed at the end of the neck and may share the diameter of the neck of the container.

The outlet hose may be connected to the opening of the neck to form a sealing engagement. It is important to avoid leakage of sealant and so the outlet hose, in whatever manner it is connected to the neck of the container, should prevent such accidental release.

In one embodiment, the outlet hose and attached tire valve connector may be continuous with and/or integrally formed with a cap which is screwed onto the neck of the container. Therefore, in one embodiment, the neck of the container is threaded to receive a threaded complimentary cap. In this embodiment, the outlet hose nozzle and attached tire valve may be considered to be connected to the opening of the neck by the cap.

In another embodiment, the outlet hose may pass through a cap screwed onto the neck of the container. In this preferred embodiment, the outlet hose may be movable and slidable within the cap. That is, the outlet hose can be drawn further out of the container until a stopper at a second end thereof abuts an under surface of the cap preventing any further extension of the outlet hose. This is convenient as an extendable outlet hose gives greater flexibility in use and ensures that the tire valve stem of the tire being repaired does not have to be located between a 4 to 8 o'clock position to thereby enable the container to be comfortably inverted prior to use. The extendable hose also allows the hose to remain neatly within the container until it is to be used.

The outlet hose may therefore extend through the cap and may have a diameter substantially similar to that of the hole in the cap to thereby form an interference wedge seal or friction fit such that sealant cannot leak around the outlet hose.

The internal passage of the outlet hose is continuous with the interior of the container. This allows sealant to be discharged through the outlet hose, when it is connected to the tire valve stem, upon pressurisation of the container.

Suitably, a first end of the outlet hose may comprise a threaded portion on the internal passage thereof. In one embodiment, this may be a simple thread to allow the outlet connector and hose to be screwed onto the valve stem of the tire valve. In other embodiments, the first end of the outlet hose may comprise an outlet connector with valve such that upon connection with the tire valve, both valves will be opened upon discharge of the pressurised sealant from the container. In such an arrangement, a spring loaded spigot built into the outlet hose connector aligns with the spring loaded spigot in the tire valve core and thereby opens a pathway for air and sealant to pass through. Another embodiment provides for the use of a standard outlet connector having a built in bridge that presses against the valve core as it is screwed onto the tire valve to thereby open it.

Embodiments of the invention will now be described by reference to the following figures whereby like numerals refer to like parts. It will be appreciated that the invention is not limited by the embodiments shown but rather these are merely exemplary to assist in understanding of the invention.

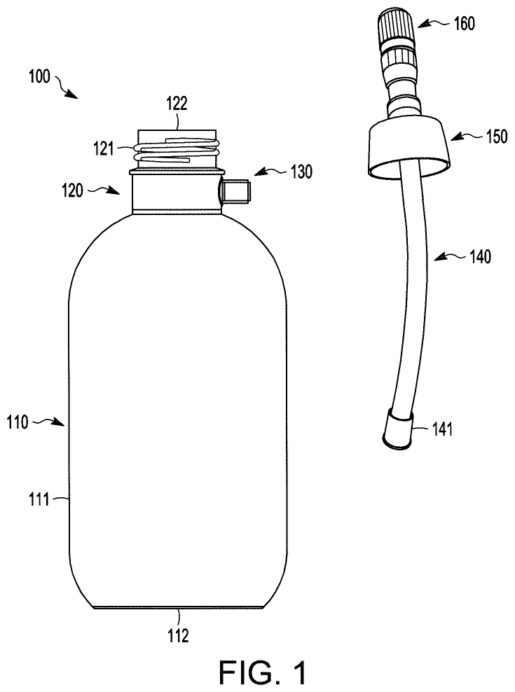

FIG. 1 is a perspective view of the exterior of one embodiment of a tire repair apparatus showing a container 100 having a body 110 formed from a continuous wall 111 and a base 112. The container 100 has an integrally formed neck 120 which, in the embodiment shown, has a threaded portion 121 and an opening 122 at its upper extent. A neck inlet 130 extends substantially at a right angle from the non-threaded region of the neck 120.

Shown separately in FIG. 1 is the outlet hose 140, which in the embodiment shown comprises and is continuous with a dip tube forming a lower portion thereof, and having a tube stopper 141 at a second end thereof. In certain embodiments, the tube stopper 141 may comprise a flow control device. One non-limiting example of such a flow control device may be a spigot and seated O-ring arrangement. The outlet hose 140 is seen to pass through a cap 150, which therefore has an aperture formed in it to accommodate passage of the outlet hose 140 and allow it to be extended or retracted through the aperture. The outlet hose 140, in the embodiment shown, has at a first end thereof an outlet connector 160 which may be a simple screw threaded connector or may comprise a spring loaded spigot valve connector and valve core. Preferred embodiments may not employ a valve core to enable the container 100 to remain metal-free.

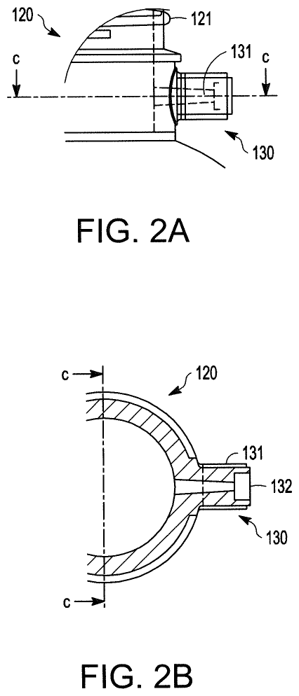

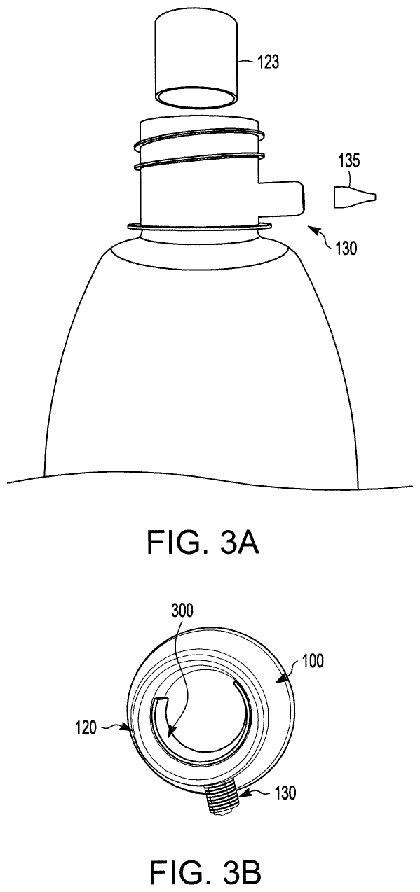

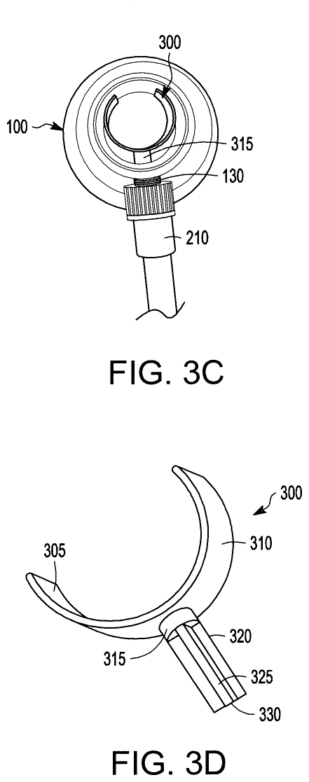

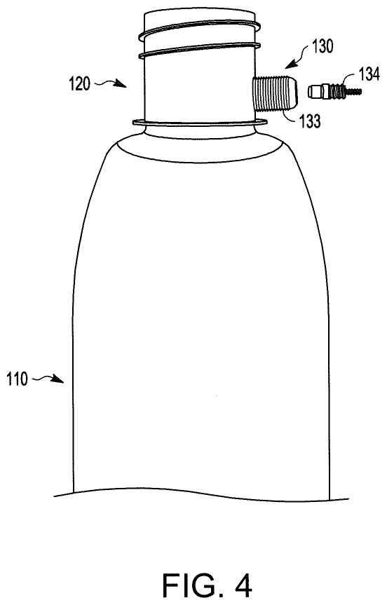

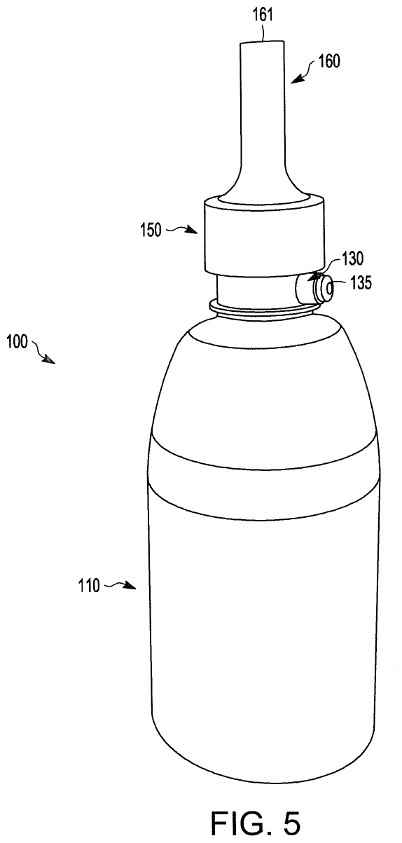

FIG. 2A is a partial view of a portion of the neck 120 and neck inlet 130 and FIG. 2B is a sectional view of a portion of the neck and neck inlet along the line c-c shown in FIG. 2A. The integrally formed neck inlet 130 is seen to have an internal channel 131, having an inlet opening 132 opposite to the first end which is adjacent the container neck 120. Internal channel 131 is shown as being tapered but it may be simpler in manufacture to have it moulded in a parallel orientation. A plug 135, as seen in FIG. 3, may be tapered or have a wedge shape.

A particular disadvantage of sealant containers of the prior art which do not have an air entry neck inlet integrally formed in the neck (and particularly not having the outlet hose extend at a right angle to such a neck inlet) is that the air, entering from locations other than the neck of the container, pressurises the bottle largely from the top of the bottle as inverted, that is the pressurised air immediately migrates to the base of the inverted bottle, and therefore forces only the sealant through the valve until the sealant has been entirely discharged. It is only at this point that the pressurised air begins to actually enter and inflate the tire. A distinct advantage of the present tire repair apparatus is that air entering via the neck inlet 130 results in the sealant being vigorously aerated as it enters the outlet hose 140 (which is typically extended until the stopper 141 abuts the under surface of the cap 150) and hence the tire, there is therefore air combining with the foaming sealant entering the tire from the beginning of the repair operation and this represents a significant saving in the time taken to inflate the tire to thereby complete the operation. The overall puncture repair and inflation time difference between using the present tire repair apparatus with the air entry through the neck inlet 130 when compared with air entry from, for example the shoulder or the base of the container 100, can be up to 90 seconds, depending on the temperature.

FIG. 3A is a partial view of a portion of the neck 120 and neck inlet 130 with a neck sleeve 123 and a tapered plug 135. The plug 135 can be inserted from the interior of the neck 120 into the first end of the internal channel 131 of the neck inlet 130. The plug 135 may be a simple rubber or plastic plug with dimensions suitable to form a seal within the inlet channel 131. The neck sleeve 123 can then be pushed into place such that it sits behind the plug 135 and keeps it in place within the inlet channel 131 to prevent the leakage and release of sealant. It will be appreciated that when an air compressor hose is connected it will press open the plug due to contact with the bridge within the threaded connector and pressurised air or other fluid is forced through the inlet channel 131 into the interior of the container 100 then the plug 135 will be displaced by the pressure and the neck sleeve 123 will flex such that an opening which is continuous with the interior of the container 100 is created to allow the pressurised air to enter. The neck sleeve 123 may be made from various flexible plastics, rubber or the same materials as suitable for the container 100, such as PET.

The embodiment shown in FIG. 3A may, in some embodiments, be preferred for environmental reasons in that the use of a plastic or rubber plug 135 allows the tire repair apparatus to be substantially metal-free in its construction as metal valves are not required. This makes the container 100 more susceptible to effective and cost efficient recycling.

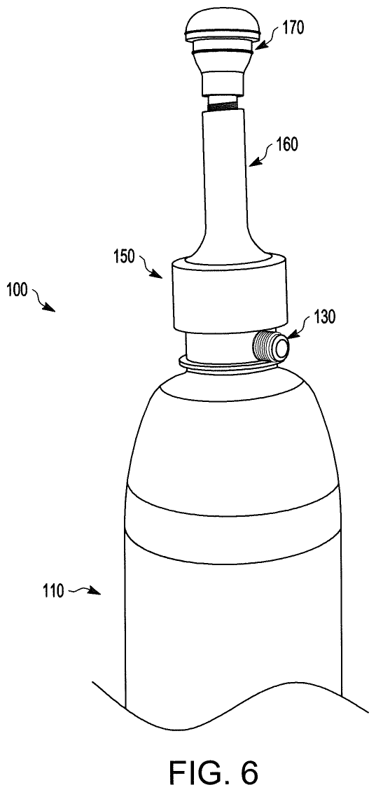

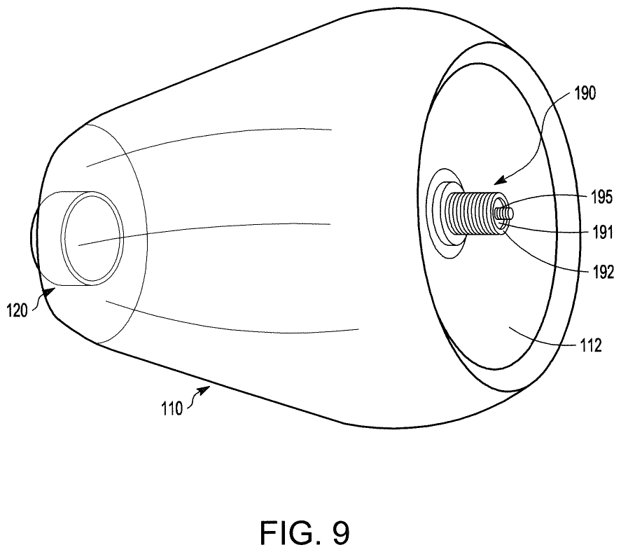

FIGS. 3B-3C show a perspective view of another embodiment of a neck sleeve while FIG. 3C shows that neck sleeve in further detail. The bulk of the container 100 is not shown in FIGS. 3B-3C for the sake of clarity. In this embodiment the neck 120 may be as described in any other embodiment and the neck inlet 130 has an outer thread, as further described in FIG. 4. The outer thread of the neck inlet 130 allows the attachment of a compressor connector 210 (as will be described for FIG. 7) through which pressurised air can be delivered to the interior of the container 100. In the embodiment shown, a partial neck sleeve 300 is placed within the interior of the neck 120 and sits, when not in use as in FIG. 3B, adjacent a portion of the interior of the neck 120.

FIG. 3D best shows the structure of the partial neck sleeve 300. It will be appreciated that the C-shaped partial neck valve 300 shown in FIG. 3D could take any form and, indeed, could even be a full neck sleeve as per FIG. 3A, but the C-shape allows for ease of placement and useful flexibility in operation. The partial neck sleeve 300 has a C-shaped body having an inner face 305 and an outer face 310 which, when placed within the neck 120, abuts against the inner surface of a portion of the neck 120. A plug 315 extends from the outer face 310 and is continuous with a splined pin 320 which, when placed, sits within the internal channel 131 of the neck inlet 130. The splined pin 320 is preferably moulded to present splines 325 and ends with an end face 330. Suitably, the partial neck sleeve 300 is a unitary design. That is, it is preferably moulded and formed as a single integral piece. While the partial neck sleeve 300 may be made from a range of suitable materials such as various plastics, other polymers and rubbers, it is preferably formed from nylon.

FIG. 3B shows the partial neck sleeve 300 located within the neck 120 and neck inlet 130 of the container 100 prior to use in dispensing sealant. The outer face 310 abuts against the inner surface of the neck 120 such that the plug 315 is located within and completely obscures a portion of the internal channel 131 of the neck inlet 130. That is, the plug 315 is an interference fit within the internal channel 131 such that sealant cannot leak through the neck inlet 130.

FIG. 3C shows the partial neck sleeve 300 as it would be positioned during dispensing of sealant. Pressurised air is being delivered through the compressor connector 210 such that it is forced against the end face 330 of the partial neck sleeve 300 and travels along the spaces between the splines 325 to also place a force against a face of the plug 315 from which the splined pin 320 extends. This pressure forces the plug 315 out of the internal channel 131 and the outer face 310 of the partial neck sleeve 300 away from the inner surface of the neck 120 such that air is able to enter the interior of the container 100 and pressurise it to force sealant to be dispensed. For the sake of clarity the outlet connector, cap and the like, which would assist in dispensing the sealant, are not shown in FIGS. 3A-C. As the partial neck sleeve 300 is forced away from the neck inlet 130, the C-shape design assists in that it can further close the open portion of the ‘C’ without significant resistance and thereby ensure the partial neck sleeve 300 is sufficiently distanced from the neck inlet 130 to allow the pressurised air to enter at an appropriate rate.

FIG. 4 is a partial view of a portion of the neck 120 and threaded neck inlet 130 with an inlet valve core 134 for insertion. FIG. 4 is therefore similar to FIG. 3 but in this embodiment instead of a tapered inlet channel 131 with a complimentary plug 135, the inlet channel 131 is threaded and is adapted to receive a complimentary inlet valve 134. If pressurised air or other fluid is forced through the inlet channel 131 into the interior of the container 100 then the inlet valve core 134 will allow the pressurised air through but will otherwise prevent the escape of sealant through inlet channel 131.

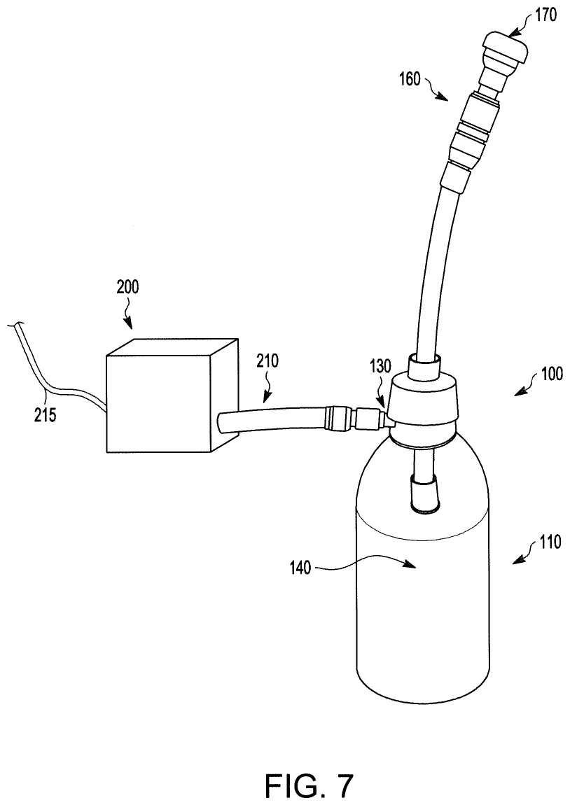

FIG. 5 is a perspective view of the exterior of a further embodiment of a tire repair apparatus which may be considered a ‘direct injection’ embodiment. The container 100 has a neck inlet 130 for connection to a pressurised air source, for example a compressor. The cap 150 may be integrally formed with the outlet connector 160 and its connecting nozzle. The outlet hose 140, in this embodiment, may therefore be considered to be a nozzle 140 which is an extension of the moulded cap 150 and does not comprise a dip tube extending into the container 100. The nozzle 140 preferably comprises an outlet connector 160, which in this embodiment is located within the bounds of the upper extent of the nozzle 140.

The nozzle 140 or underside of cap 150 may comprise within its internal passage a simple O-ring surrounding a projection spigot with the O-ring, when seated, covering one or more apertures. When the interior of the container 100 is pressurised then the O-ring is lifted off its seat and sealant can pass through the internal passage of the outlet connector 160 and connector. Such an arrangement is described in WO 2007/030896, in the present applicant's name, the entire disclosure of which is hereby incorporated by reference in its entirety. This will prevent accidental leakage of sealant as a positive pressure inside the container 100 is required to displace the O-ring and open the passageway for sealant flow. Such an arrangement may be replaced with a rubber plug or other like arrangement, as would be appreciated by a person of skill in the art.

The open end 161 of the nozzle 140 having a connector 160 portion may comprise an internal thread to allow it to be screwed onto a tire valve stem. If the sealant comprises relatively large particles or fibres which may block the valve core of the tire then the valve core may be removed and the outlet connector 160 portion attached and, when pressurised air is forced through the neck inlet 130, the sealant will be forced into the tire. With the embodiment show in FIG. 5, the lack of an extendable outlet hose 140 means that the tire valve must be between the 4 and 8 o'clock positions as there is limited ability to invert the container, as is preferable before use, in any other position. This means the driver of the vehicle must ensure the vehicle has stopped in an appropriate position to achieve this before attending to the repair. Despite this inconvenience, the embodiment of FIG. 5 will still be appropriate for tire repair.

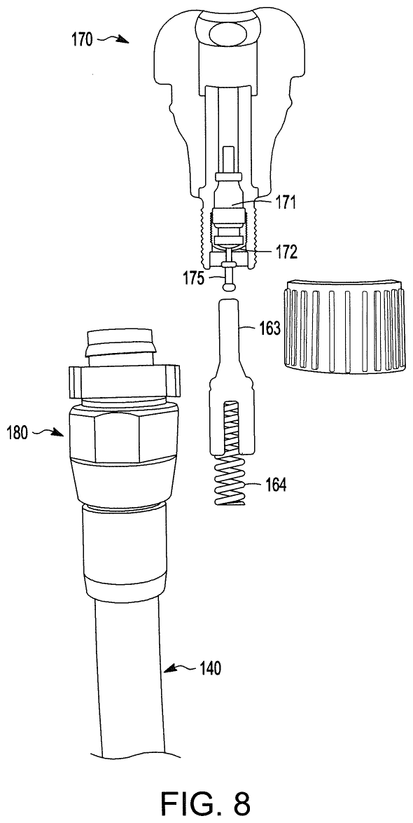

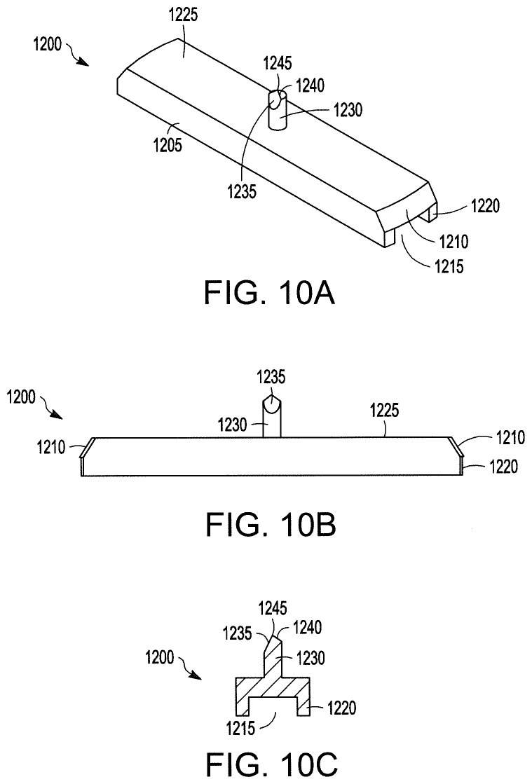

FIG. 6 is a similar embodiment to the tire repair apparatus of FIG. 5 but with the addition of a tire valve 170. The tire valve 170 is merely representative of a true tire valve stem, as would be on the tire rim, and is shown in FIG. 6 to show the connection thereof the tire repair apparatus 100 of the invention. To be clear, the tire valve 170 is not a part of the present invention and is only shown for the sake of indicating the arrangement of container 100 in use. The outlet connector 160 will, as described above, connect with the tire valve 170 and permit the transfer of sealant from the container 100 into the interior chamber of the tire. However, the valve in the outlet hose 140 will ensure that sealant cannot escape from the container 100 until the interior of the container 100 is pressurised. The outlet connector comprises, as described in further detail in relation to FIG. 8, a spring and spigot arrangement to ensure that the valve core of the tire valve is opened to receive the sealant during repair. The act of screwing on or otherwise attaching the outlet connector 160 to the tire valve brings the spigot arrangement into contact with the tire valve core and the spigot depresses the plunger of the tire valve core to open a continuous flow path between container 100 interior and the interior of the tire.

FIG. 7 is a perspective view of the exterior of yet a further embodiment of a tire repair apparatus showing attached compressor 200. The embodiment of FIG. 7 is ready for use to repair a puncture in a pneumatic tire. The compressor connector 210 has been joined to the neck inlet 130 of the container 100. The power lead 215 of the compressor 200 is connected to a power source (not shown) which may be the standard DC connector of the car. The outlet connector 160 is attached to the valve stem of the tire valve, represented by tire valve 170, and the container 100 ready to be inverted. Preferably, the outlet hose 140 is extended such that the second end has the stopper 141 abutting against the under surface of the cap 150. This will allow all sealant to be easily discharged following inversion.

The extension of the outlet hose 140 also allows flexibility in connecting the valve stem and connector 160 with the tire valve and means that the container can be easily inverted whatever position the tire valve is in.

FIG. 8 is a view of sections of the tire valve 170 of FIGS. 6 and 7 and the interior of one embodiment of the outlet connector 160 showing connection of the two and attachment of the outlet connector 160 to the outlet hose 140. The outlet hose 140 ends in a joiner 180 which receives the outlet hose 140 and which has an end portion adapted to receive the tire valve 170. The internal arrangements can be seen whereby spring 164 of outlet connector 160 is connected to a spigot 163 which in turn can engage with a plunger 175. Plunger 175 is part of a standard tire valve core arrangement and so has a valve seat 172 as part of the valve core 171. The spigot 163 of the outlet connector 160 will engage with the plunger 175, when they are screwed together, to thereby open both the valve cores to allow the flow of sealant.

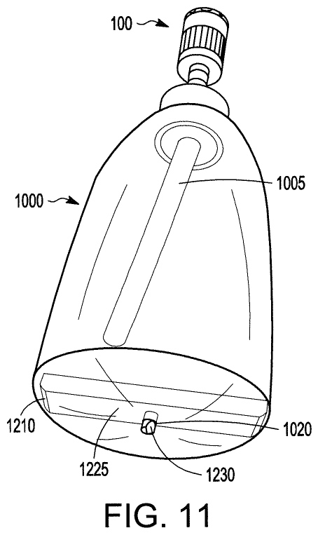

FIG. 9 is a perspective view of the base of still a further embodiment of a tire repair apparatus having a base inlet 190 integrally formed into the base 112 of the container 100 instead of a neck inlet. The base inlet 190 will take the form as described previously for the neck inlet 130, and so will have an internal channel 191, having an inlet opening 192 opposite to the first end which is adjacent the base 112. The base is formed to be concave to allow space for the extending base inlet 190. As described for the neck inlet 130, the base inlet 190 may be screw threaded (as shown in FIG. 9) to receive a base valve 195 or it may not be screw threaded and instead may have a tapered or parallel internal channel 191 which may receive a blow in rubber plug, tapered or wedge shaped plug, or the like.

The base inlet 190 can therefore take the form of a tube or spigot and may be used purely for the injection of a pressurised fluid, such as air, into the container. This may assist in generating sufficient pressure to timely discharge the sealant formulation as an alternative to the neck inlet embodiments described above.

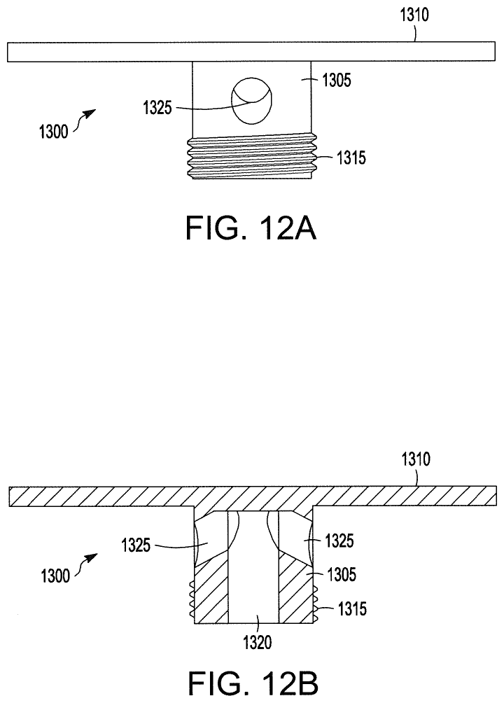

FIGS. 10A-C show a pressure release device 1200 forming part of the pressure release system. The pressure release device 1200, in the embodiment shown, comprises an elongate body 1205 which at each end, on an upper surface thereof, presents chamfered faces 1210. It should be appreciated that the pressure release device 1200 is not limited to this particular shape but rather it is designed to conform with that of the sealant container 1000 it is to be located within. The pressure release device 1200 could equally be circular to substantially conform to the bottom inner surface of the sealant container 1000 but the elongate bar-shape of FIG. 10A is both effective and efficient in design. The underside of the pressure release device 1200, as seen in FIGS. 10A and 10C, has a cut away or open section 1215 defined by walls 1220. The open section 1215 reduces the weight and materials expense of the pressure release device 1200. The chamfered faces 1210 are joined by a sealing face 1225 from which, in a generally central region, extends a sealing spigot 1230. The sealing spigot 1230 ends in a first inclined face 1235 and a second inclined face 1240 thereby also forming an apex 1245 at the upper extent of the sealing spigot 1230. The sealing spigot 1230 is tapered up to the apex 1245 to allow a gradual discharge, rather than a sudden release of sealant formulation when and if the spigot suddenly opened. This allows for a more controlled release of pressure.

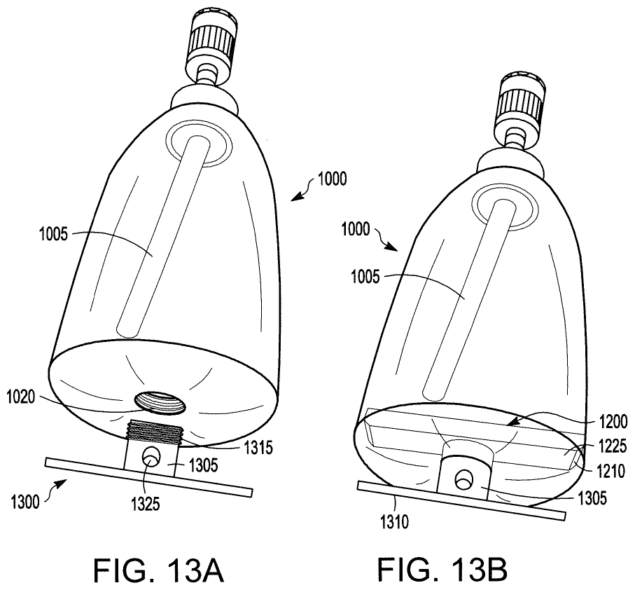

FIG. 11 shows the pressure release device 1200 in place within the sealant container 1000, which in this figure does not show the neck inlet and other detailed components of the sealant container 1000. The outlet coupling 100 and hose outlet 1005 are as previously discussed but, in this embodiment, the sealant container 1000 is provided with a container aperture 1020 which is formed in the base of the sealant container 1000. The sealing spigot 1230 is seen to pass through the container aperture 1020 and, in the embodiment shown, forms a simple interference fit therein. It can also be seen that the chamfered faces 1210 of the pressure release device 1200 allow for it to be snugly wedged against the walls of the sealant container 1000. The particular engagement of the chamfered faces 1210 with the sealant container 1000 will clearly depend on the shape and internal features of the sealant container 1000 but, in preferred embodiments, they are conveniently wedged under small formations or dimples (not shown in the figures) formed in the walls of the sealant container 1000 or, alternatively, wedged against any inward curvature of the walls. The pressure release device 1200 is thereby securely locked in place to prevent being dislocated due to any sudden inertia.

In use, the internal pressure generated within a plastic sealant container 1000 will, when excessive, most notably cause the generally convex base to be distorted and forced away from the sealing face 1225 of the pressure release device 1200. As the pressure release device 1200 itself is held in place by its engagement with the convex dimples in the walls of the sealant container 1000 or the curvature of those walls, the result is that the container base, and so the container aperture 1020, are caused to move along the sealing spigot 1230 away from the sealing face 1225 and towards the apex 1245. Once the container aperture 1020 passes the initial sloping portion of the first inclined face 1235 this creates an opening which allows sealant formulation and air to pass through, thereby reducing the pressure within the sealant container 1000. The closer the container aperture 1020 gets to the apex 1245 then the greater becomes the opening, with the second inclined face 1240 becoming involved. Under more extreme pressures the base may even extend beyond the apex 1245 such that the entire container aperture 1020 is unobstructed, allowing the maximum pressure release. While this system will allow sealant formulation to stream out of the container aperture 1020, at pressure, this is nonetheless a safer outcome than risking the entire sealant container exploding.

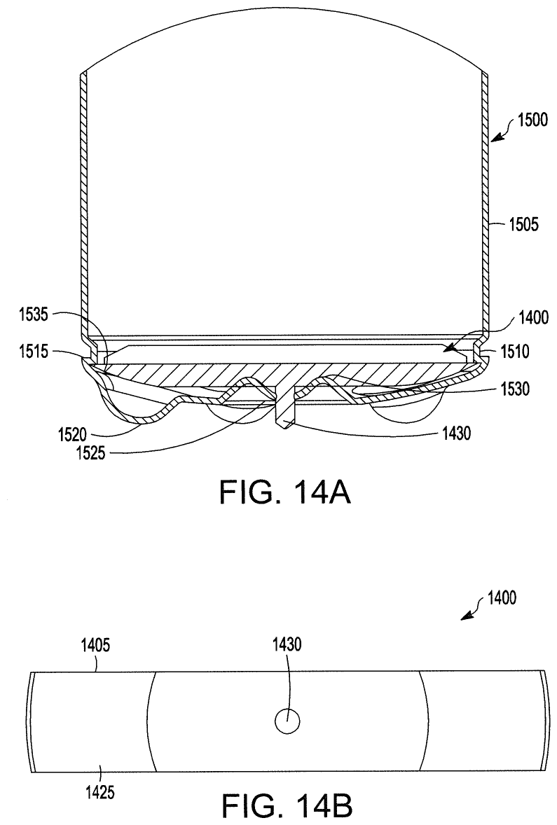

An additional safety component of the pressure release system is incorporated and shown in FIGS. 12A and 12B as a deflection baffle 1300. The deflection baffle 1300 comprises a generally circular (in cross section) body 1305 and a baffle head 1310. At the end of the body 1305 opposite to that intersecting the baffle head 1310 is a baffle threaded portion 1315. A central channel 1320 is formed within the body 1305 and opens at its lower extent. The central channel 1320 is intersected by additional channels 1325 which in the embodiments shown are two angled channels 1325 which may sit at an angle of approximately 60 degrees to the central channel 1320.

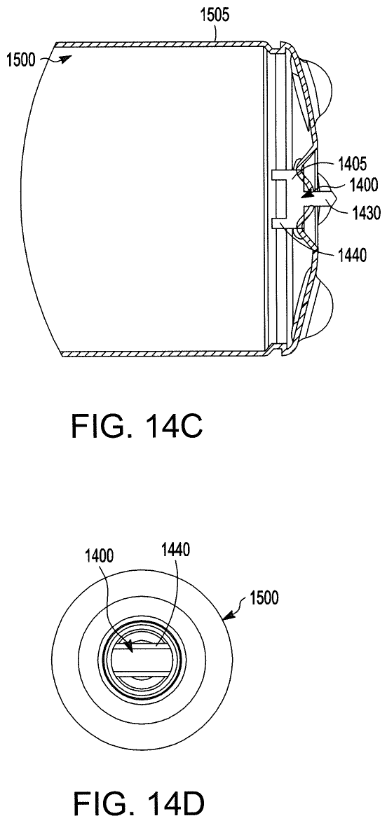

FIGS. 13A and 13B show the manner of engagement of the deflection baffle 1300 with the sealant container 1000 and with the pressure release system, respectively. In FIG. 13A it can be seen that, in this embodiment, the container aperture 1020 is threaded such that it can receive and engage with the baffle threaded portion 1315 of the baffle body 1305. This results in the deflection baffle 1300 being affixed to the exterior of the base of the sealant container 1000 with the central channel 1320 open to the interior of the sealant container 1000 and the ends of the angled channels 1325 which open through the body 1305 being external to the sealant container 1000.

FIG. 13B shows the deflection baffle 1300 fixed in place, as described, and the pressure release device 1200 also lodged in place as described for FIG. 11. The engagement of the deflection baffle 1300 in the container aperture 1020 means that when the sealing spigot 1230 of the pressure release device 1200 passes through the container aperture 1020, it is accommodated within the central channel 1320 of the deflection baffle 1300 and thereby provides a sealing engagement which prevents the passage of sealant formulation. When the internal pressure within the sealant container increases such that the base is deformed outwards, as described above for FIG. 11, then the deflection baffle 1300 also moves along the sealing spigot 1230 until, again, an opening is formed for the escape of pressurised sealant formulation. The difference provided for in the embodiment of FIG. 13B is the fluid path control effect provided for by the deflection baffle 1300. The pressurised sealant will pass along the central channel 1320 and then be directed into the angled channels 1325. Due to the particular angle of the angled channels 1325, the sealant will be harmlessly directed back into the exterior of the container base. The introduction of a deflection baffle 1300 therefore provides significant benefits in the safe usage of the pressure release system.

It will be appreciated that the shape of the baffle head 1310 is not of particular importance and the body 1305 simply has to have a region which can engage within the container aperture 1020. While the embodiment shown has a screw-threaded engagement, it will be appreciated that many other connections can be envisaged. Further, while two additional or angled channels 1325 provide for an effective controlled pressure release, it should be understood that a single such additional channel formed at any angle which either directs the pressurised sealant onto the exterior of the container base or onto the deflection baffle head 1310 may also be appropriate.

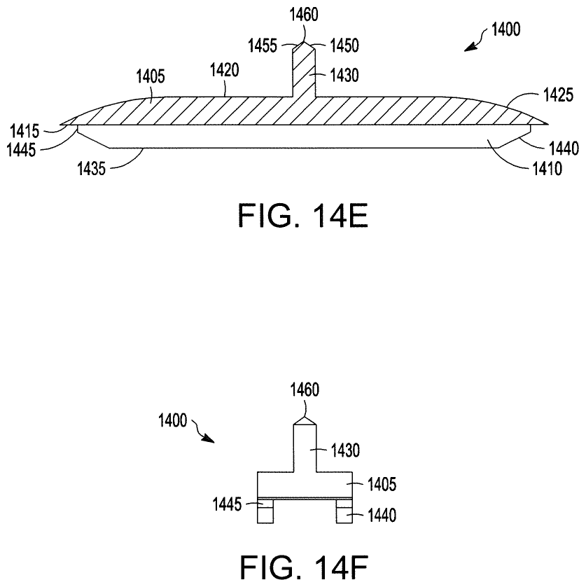

FIGS. 14A to 14F show a further embodiment of a pressure release device 1400, forming part of the pressure release system, and its placement in a sealant container 1500. Only the base region of the sealant container 1500 is shown in FIGS. 14A and 14C but the structure is similar to the containers as discussed in the other figures, including FIG. 11. However, in the embodiment show in FIG. 14A, the sealant container 1500 has continuous walls 1505 which, at the lower extent thereof, form indent 1510. Internally, the indent 1510 results in an overhang 1515 partially jutting out from the inner surface of the walls over the base 1520. A raised portion 1525 is formed in the base 1520 in the shape of sloped peaks 1530 on which the pressure release device 1400 may be located.

The pressure release device 1400 itself is best seen in FIGS. 14B, 14E and 14F and has an elongate body 1405 and a sealing face 1420 which, at each end thereof, presents sloped regions 1425. The underside of the pressure release device 1400, as seen in FIG. 14F, has a cut away or open section 1415 defined by walls 1410. The pressure release device 1400 has a sealing spigot 1430 extending from the sealing face 1420 and the sealing spigot 1430 may end in a first inclined face 1450 and a second inclined face 1455 thereby forming an apex 1460 at the upper extent of the sealing spigot 1430, in the manner already described for FIGS. 10A to 10C.

FIG. 14E best shows the profile of the pressure release device 1400 and demonstrates the fact that the sloped regions 1425 overhang the walls 1410 on the underside of the device 1400. This overhang forms a flange 1415 jutting directly over end faces 1445 of walls 1410, which end faces 1445 are joined by angled regions 1440 to the wall base 1435.

FIG. 14A shows the manner in which the pressure release device 1400 clips into place within the interior of sealant container 1500 with the flange 1415 abutting against the overhang 1515 of the container 1500. This assists in locking the pressure release device 1400 safely into place. FIG. 14C shows an end on view of this placement of the pressure release device 1400 within the container 1500 with the sealing spigot 1430 located within an aperture of the container base 1520. FIG. 14D shows the placement from the underside of the container 1500. In use, the container base 1520 can move exactly as described for FIG. 11 to allow pressure to be released once the sealing spigot 1430 leaves at least some gap within the aperture for sealant to escape.

It may be beneficial for the base of the container 1500 to have a raised portion within a generally central region of the base. This allows that area to expand outwardly when the internal pressure within the container 1500 increases and therefore encourages migration along the length of the sealing spigot 1430.

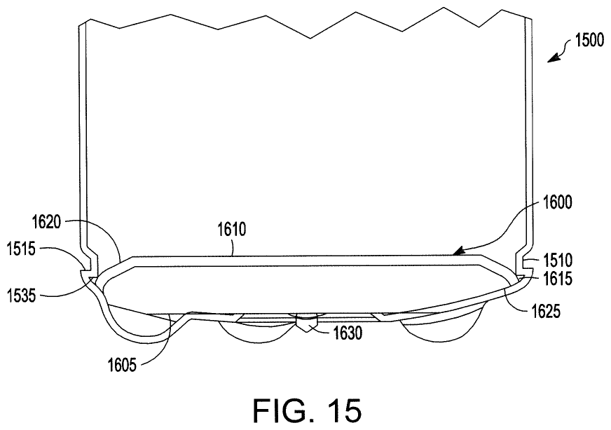

FIG. 15 shows container 1500, which is as already described for FIGS. 14A and 14C. A further embodiment of a pressure release device 1600 is shown which generally equates to that described for FIGS. 14A to F in that it has an elongate body 1605 and a sealing surface 1625 and walls or runners 1610 on the underside. It also has angled regions 1620 leading from the walls 1610 to the sealing face 1625. Near the point where the angled regions 1620 meet the sealing face 1625 there is seen to be a curved end 1615. While the embodiment of FIG. 14 had a flange, this embodiment simply employs the curved ends 1615 to engage with the overhang 1515 in an interference fit. This embodiment of the pressure release device 1600 otherwise operates as previously described for device 1400.

A particularly important benefit of the pressure release systems described herein stems from the fact that compressors are freely available to consumers from many retailers which achieve up to 300 psi. Due to their low cost, these compressors are increasingly popular but can be extremely dangerous when used in combination with a standard sealant container which may only be rated to 150-200 psi, at best. If such a compressor is used to dispense sealant and any form of blockage, such as dirt, finds its way into the system or if the connector becomes cross-threaded during placement such that the valve spigot is not activated to allow passage of air and sealant into the tire, then the pressure will quickly build to dangerous levels. The user would have very little time to observe the problem and turn off the compressor and the most likely outcome is the explosion of the bottle with sealant being spread at high pressure causing potential harm to both the user's person and the vehicle. The use of a pressure release system, as described herein, introduces a safeguard to avoid such an incident and is a distinct advantage of embodiments employing this system.

In a second aspect, the invention provides for a method of sealing a puncture in a pneumatic tire including the steps of:
(a) providing a tire repair apparatus comprising;
   i. a container having a body, a base and a neck, the container substantially made from PET and the container containing a sealant formulation;
   ii. one of the neck or the base having an integrally formed inlet extending therefrom;
   iii. an outlet hose extending from an opening of the neck and wherein the neck or base inlet comprises a valve or plug within an internal channel thereof;
(b) connecting the outlet hose to a valve of the pneumatic tire;
(c) supplying a fluid pressure through the neck or base inlet of the container;

to thereby discharge sealant formulation from the container into an internal chamber of the pneumatic tire and seal the puncture.

The method may further comprise the step of inverting the container prior to step (c).

The fluid pressure may be pressurised air. This may be supplied by a compressor or the like.

The method of the second aspect may be performed using the tire repair apparatus as described in any one or more embodiments of the first aspect.

In one embodiment, the pneumatic tire is a tire of a car, van, truck or bicycle. The present apparatus will find common use in the repair of car tires.

Preferably, only the neck has the integrally formed neck inlet and the base inlet is not present.

The above description of various embodiments of the present invention is provided for purposes of description to one of ordinary skill in the related art. It is not intended to be exhaustive or to limit the invention to a single disclosed embodiment. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

In the claims which follow and in the preceding description of the invention, except where the context clearly requires otherwise due to express language or necessary implication, the word “comprise”, or variations thereof including “comprises” or “comprising”, is used in an inclusive sense, that is, to specify the presence of the stated integers but without precluding the presence or addition of further integers in one or more embodiments of the invention.

1. A tire repair apparatus comprising:
(a) a container having a body, a base and a neck, the container made from at least 90% PET;
(b) the neck having an integrally formed inlet extending therefrom;
(c) an outlet hose extending from an opening of the neck; and
(d) a pressure release device comprising a sealing face having a sealing spigot extending there from and passing through an aperture formed in the base,
wherein, the neck and a neck inlet are integrally formed with the container body, and the neck inlet comprises a valve or plug within an internal channel thereof.

2. The apparatus of claim 1 wherein the container is made from at least 95% PET.

3. (canceled)

4. The apparatus of claim 1 wherein the neck has the integrally formed neck inlet in the form of a spigot.

5. The apparatus of claim 1 wherein the internal channel of the neck inlet has a first opening which is continuous with an interior of the container.

6. The apparatus of claim 1 wherein the outlet hose is connected to the opening of the neck to form a sealing engagement.

7. The apparatus of claim 1 wherein a first end of the outlet hose may comprise a threaded portion on an internal passage.

8. The apparatus of claim 1 wherein the outlet hose is extendable.

9. The apparatus of claim 8 wherein the outlet hose is continuous with a dip tube which opens into an interior of the container.

10. The apparatus of claim 1 wherein a neck sleeve is inserted into an interior surface of the neck of the container.

11. The apparatus of claim 10 wherein the neck sleeve is a partial neck sleeve comprising a plug which extends into the internal channel of the neck inlet.

12. (canceled)

13. (canceled)

14. The apparatus of claim 1 wherein the neck inlet comprises a plug within an internal channel thereof.

15. The apparatus of claim 1 wherein the tire repair apparatus is substantially metal-free.

16. (canceled)

17. The apparatus of claim 1 wherein the pressure release device further comprising a sealing spigot and wherein the sealing spigot of the pressure release device forms a sealing engagement within the aperture.

18. The apparatus of claim 1 wherein the sealing spigot has at least one inclined face at an end thereof furthest from a sealing face of the pressure release device.

19. The apparatus of claim 1 wherein the pressure release device comprises at least one chamfered face to engage with the container.

20. The apparatus of claim 1 wherein the pressure release device comprises a flange which, in use, locks against an overhang formed within the container.

21. The apparatus of claim 20 wherein the flange of the pressure release device is formed from an extension of a sealing surface beyond an extent of a wall on an underside of the pressure release device.

22. (canceled)

23. The apparatus of claim 1 wherein the pressure release system further comprises a deflection baffle which engages with the aperture.

24. The apparatus of claim 23 wherein the deflection baffle engages with the aperture and the sealing spigot of the pressure release device is accommodated within the deflection baffle.

25. A method of sealing a puncture in a pneumatic tire including the steps of:
(a) providing a tire repair apparatus comprising;
i. a container having a body, a base and a neck, the container made from at least 90% PET and the container containing a sealant formulation;
ii. the neck having an integrally formed neck inlet extending therefrom wherein the neck and the neck inlet are integrally formed with the container body;
iii. an outlet hose extending from an opening of the neck and wherein the neck inlet comprises a valve or plug within an internal channel thereof; and
iv. a pressure release device comprising a sealing face having a sealing spigot extending therefrom and passing through an aperture formed in the base;
(b) connecting the outlet hose to a valve of the pneumatic tire;
(c) supplying a fluid pressure through the neck inlet of the container;
to thereby discharge sealant formulation from the container into an internal chamber of the pneumatic tire and seal the puncture

26. (canceled)
